(19) United States
(12) Patent Application Publication
(10) Pub. No.: US 2017/0231245 A1
(43) Pub. Date: Aug. 17, 2017

(54) METHOD OF FORMING A SHELF-STABLE READY-TO-DRINK COFFEE PRODUCT

(71) Applicant: Zingerman's Coffee Company, LLC, Ann Arbor, MI (US)

(72) Inventor: Steven Mangigian, Ann Arbor, MI (US)

(73) Assignee: Zingerman's Coffee Company, LLC, Ann Arbor, MI (US)

(21) Appl. No.: 15/043,756

(22) Filed: Feb. 15, 2016

(51) Int. Cl. A23F 5/26; A23F 5/08; A23F 5/04

(52) U.S. Cl. CPC A23F 5/267; A23F 5/04; A23F 5/08

(57) ABSTRACT

A method of forming a ready-to-drink coffee product includes contacting a first ground coffee composition with water having a temperature of less than 10° C. for at least 16 hours to form a first cold brew concentrate; mixing the cold brew concentrate and water to form a mixture; heating the mixture to a temperature of less than 100° C. for less than 1 minute to form a pre-fill coffee composition; pouring the pre-fill coffee composition into a cavity; concurrent to pouring, increasing a temperature of the pre-fill coffee composition to at least 82.2° C. and holding the pre-fill coffee composition at the temperature of at least 82.2° C. for at least 30 seconds to form a filled coffee composition; and cooling the filled coffee composition to ambient temperature within the cavity to form the ready-to-drink coffee product. A ready-to-drink coffee product system is also disclosed.

### TECHNICAL FIELD

The disclosure relates to a method of forming a ready-to-drink coffee product.

### BACKGROUND

Ready-to-drink beverages, such as iced tea, coffee, fruit juice, and dairy drinks, are generally provided in fully prepared form and are therefore ready for immediate consumption by a consumer. That is, ready-to-drink beverages are generally formulated to be shelf-stable, transportable, and storable, often under refrigeration, for a predetermined time period. Therefore, ready-to-drink beverages are a convenient option for consumers who prefer prepared beverages.

However, shelf life and spoilage organisms are engineering challenges for ready-to-drink beverages. Industry techniques such as retort heating, aseptic processing, and pH control sufficiently inhibit spoilage organisms and extend shelf life, but also detrimentally affect a taste of the ready-to-drink beverage. Therefore, additives such as flavorants, sweeteners, preservatives, and/or acidulants must be added to the ready-to-drink beverage.

### SUMMARY

A method of forming a ready-to-drink coffee product includes contacting a first ground coffee composition with water having a temperature of less than 10° C. for at least 16 hours to form a first cold brew concentrate. The method also includes mixing the first cold brew concentrate and water having a temperature of less than 10° C. to form a mixture. In addition, the method includes heating the mixture to a temperature of less than 100° C. for less than 1 minute to thereby form a pre-fill coffee composition. After heating, the method includes pouring the pre-fill coffee composition into a cavity defined by a container. Concurrent to pouring, the method includes increasing a temperature of the pre-fill coffee composition to at least 82.2° C. and holding the coffee composition at the temperature of at least 82.2° C. for at least 30 seconds to form a filled coffee composition. The method also includes, after increasing the temperature, cooling the filled coffee composition to ambient temperature within the cavity to thereby form the ready-to-drink coffee product.

In one embodiment, a method of forming a ready-to-drink coffee product includes roasting a first green coffee material and a second green coffee material that is different from the first green coffee material to form a first roasted coffee composition and a second roasted coffee composition, respectively. The method also includes grinding the first roasted coffee composition and the second roasted coffee composition to form a first ground coffee composition and a second ground coffee composition, respectively. The method further includes contacting the first ground coffee composition with water having a temperature of less than 10° C. for at least 16 hours to form a first cold brew concentrate. The method also includes contacting the second ground coffee composition with water having a temperature of less than 10° C. for at least 16 hours to form a second cold brew concentrate. In addition, the method includes blending together the first cold brew concentrate and the second cold brew concentrate to form an assemblage concentrate, and mixing the assemblage concentrate and water having a temperature of less than 10° C. to form a mixture. The method includes heating the mixture to a temperature of less than 100° C. for less than 1 minute to form a pre-fill coffee composition. After heating, the method includes pouring the pre-fill coffee composition into a cavity defined by a container. Concurrent to pouring, the method includes increasing a temperature of the pre-fill coffee composition to at least 82.2° C. and holding the pre-fill coffee composition at the temperature of at least 82.2° C. for at least 30 seconds to form a filled coffee composition. After increasing the temperature, the method includes cooling the filled coffee composition to ambient temperature within the cavity to thereby form the ready-to-drink coffee product.

A ready-to-drink coffee product system includes a container defining a cavity, a cap disposed on the container so that the cavity is sealed off from an ambient environment, and a ready-to-drink coffee product disposed within the cavity. The ready-to-drink coffee product is formed by contacting a first ground coffee composition with water having a temperature of less than 10° C. for at least 16 hours to form a first cold brew concentrate; mixing the first cold brew concentrate and water having a temperature of less than 10° C. to form a mixture; heating the mixture to a temperature of less than 100° C. for less than 1 minute to thereby form a pre-fill coffee composition; after heating, pouring the pre-fill coffee composition into a cavity defined by a container; concurrent to pouring, increasing a temperature of the pre-fill coffee composition to at least 82.2° C. and holding the coffee composition at the temperature of at least 82.2° C. for at least 30 seconds to form a filled coffee composition; and after increasing the temperature, cooling the filled coffee composition to ambient temperature within the cavity to thereby form the ready-to-drink coffee product.

For the present disclosure, “a”, “an”, “the”, “at least one”, and “one or more” are used interchangeably to indicate that at least one of the items is present. A plurality of such items may be present unless the context clearly indicates otherwise. In addition, disclosure of ranges includes disclosure of all values and further divided ranges within the entire range. The terms “comprises,” “comprising,” “including,” and “having” are inclusive and therefore specify the presence of stated items, but do not preclude the presence of other items. The term “or” includes any and all combinations of one or more of the associated listed items.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a ready-to-drink coffee product system including a ready-to-drink coffee product disposed in a container;

FIG. 2 is a flowchart of a method of forming the ready-to-drink coffee product of FIG. 1; and

FIG. 3 is a flowchart of another embodiment of the method of forming the ready-to-drink coffee product of FIG. 1.

### DETAILED DESCRIPTION

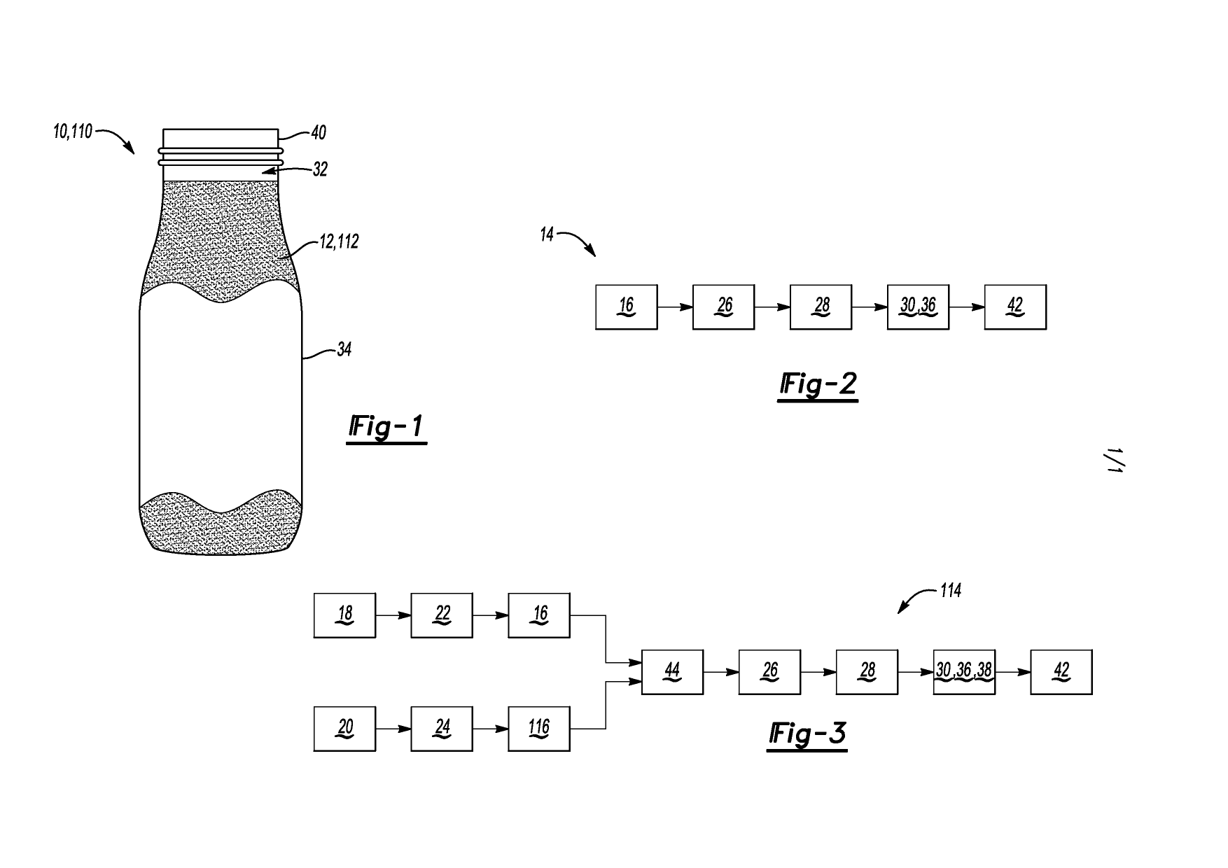

Referring to the Figures, wherein like reference numerals refer to like elements, a ready-to-drink coffee product system 10, 110 is shown generally in FIG. 1. The ready-to-drink coffee product system 10, 110 may be useful for beverage applications requiring quality and convenience for a consumer. That is, the ready-to-drink coffee product system 10, 110 is shelf-stable, i.e., transportable and storable at ambient conditions without refrigeration, for at least one year. More specifically, the ready-to-drink coffee product system 10, 110 includes a ready-to-drink coffee product 12, 112 that is flavorful, packaged for convenience, and storable and transportable for at least one year without refrigeration before consumption.

A method 14, 114 of forming the ready-to-drink coffee product 12, 112 is shown generally in FIGS. 2 and 3. The method 14, 114 may be characterized as a cold-brew process. That is, as set forth in more detail below, the method 14, 114 includes brewing coffee with water that has a temperature of less than 10° C., e.g., room-temperature water or cold water. In one embodiment shown generally in FIG. 3, the method 114 includes an assemblage process in which two varieties of coffee are assembled or combined to produce the ready-to-drink coffee product 112 and system 110.

Referring now to FIG. 2, the method 14 includes contacting 16 a first ground coffee composition with water having a temperature of less than 10° C. for at least 16 hours to form a first cold brew concentrate, as set forth in more detail below. However, to form the first ground coffee composition, the method 14 may first include roasting 18 (FIG. 3) a first green coffee material to form a first roasted coffee composition, and grinding 22 (FIG. 3) the first roasted coffee composition to form the first ground coffee composition.

The first green coffee material may include a first plurality of coffee beans or seeds harvested from a coffee plant, such as, by way of non-limiting examples, a Coffea arabica plant or a Coffea canephora plant, i.e., a Coffea robusta plant. The first green coffee material is unroasted and in natural form, may be mature or immature, and has an intact wax layer on an outer surface of each of the first plurality of coffee beans.

Suitable examples of the first green coffee material include, but are not limited to, a first plurality of beans harvested from one or more of the following coffee plants: Coffea abbayesii, Coffea affinis, Coffea alleizettii, Coffea ambanjensis, Coffea ambongenis, Coffea andrambovatensis, Coffea ankaranensis, Coffea anthonyi, Coffea arabica, Coffea arenesiana, Coffea augagneurii, Coffea bakossii, Coffea benghalensis, Coffea bertrandii, Coffea betamponensis, Coffea bissetiae, Coffea boinensis, Coffea boiviniana, Coffea bonnieri, Coffea brassii, Coffea brevipes, Coffea bridsoniae, Coffea buxifolia, Coffea canephora, Coffea carrissoi, Coffea charrieriana, Coffea cochinchinensis, Coffea commersoniana, Coffea congensis, Coffea costatifructa, Coffea coursiana, Coffea dactylifera, Coffea decaryana, Coffea dubardii, Coffea ebracteolata, Coffea eugenioides, Coffea fadenii, Coffea farafanganensis, Coffea floresiana, Coffea fotsoana, Coffea fragilis, Coffea fragrans, Coffea gallienii, Coffea grevei, Coffea heimii, Coffea homollei, Coffea horsfieldiana, Coffea humbertii, Coffea humblotiana, Coffea humilis, Coffea jumellei, Coffea kapakata, Coffea kianjavatensis, Coffea kihansiensis, Coffea kimbozensis, Coffea kivuensis, Coffea labatii, Coffea lancifolia, Coffea lebruniana, Coffea leonimontana, Coffea leroyi, Coffea liaudii, Coffea liberica, Coffea ligustroides, Coffea littoralis, Coffea lulandoensis, Coffea mabesae, Coffea macrocarpa, Coffea madurensis, Coffea magnistipula, Coffea malabarica, Coffea mangoroensis, Coffea mannii, Coffea manombensis, Coffea mapiana, Coffea mauritiana, Coffea mayombensis, Coffea mcphersonii, Coffea melanocarpa, Coffea merguensis, Coffea millotii, Coffea minutiflora, Coffea mogenetii, Coffea mongensis, Coffea montekupensis, Coffea montis-sacri, Coffea moratii, Coffea mufindiensis, Coffea myrtifolia, Coffea namorokensis, Coffea neobridsoniae, Coffea neoleroyi, Coffea perrieri, Coffea pervilleana, Coffea pocsii, Coffea pseudozanguebariae, Coffea pterocarpa, Coffea racemosa, Coffea rakotonasoloi, Coffea ratsimamangae, Coffea resinosa, Coffea rhamnifolia, Coffea richardii, Coffea sahafaryensis, Coffea sakarahae, Coffea salvatrix, Coffea sambavensis, Coffea sapinii, Coffea schliebenii, Coffea semsei, Coffea sessiliflora, Coffea stenophylla, Coffea tetragona, Coffea togoensis, Coffea toshii, Coffea travancorensis, Coffea tricalysioides, Coffea tsirananae, Coffea vatovavyensis, Coffea vavateninensis, Coffea vianneyi, Coffea vohemarensis, Coffea wightiana, and Coffea zanguebariae.

Further, the first green coffee material may be procured or sourced from any coffee-producing jurisdiction, such as, but not limited to, one or more of Brazil, Vietnam, Colombia, Indonesia, Ethiopia, India, Mexico, Guatemala, Peru, Honduras, Uganda, Ivory Coast, Costa Rica, El Salvador, Nicaragua, Papua New Guinea, Ecuador, Thailand, Tanzania, Dominican Republic, Kenya, Venezuela, Cameroon, Philippines, Democratic Republic of the Congo, Burundi, Madagascar, Haiti, Rwanda, Guinea, Cuba, Togo, Bolivia, Zambia, Angola, Central African Republic, Panama, Zimbabwe, United States, Nigeria, Ghana, Jamaica, Sri Lanka, Malawi, Paraguay, Sierra Leone, Australia, Trinidad and Tobago, Nepal, Republic of the Congo, Equatorial Guinea, Gabon, and Benin.

As set forth above, the method 14 may include roasting 18 the first green coffee material to form the first roasted coffee composition. More specifically, roasting 18 may include cooking the first plurality of coffee beans according to a time-temperature profile or schedule in a coffee roaster. For example, the first plurality of beans may be roasted in a drum roaster, a hot-air roaster, a packed-bed roaster, a tangential roaster, or a centrifugal roaster. In addition, roasting 18 may include cooking the first plurality of coffee beans in either a batch mode or a continuous mode.

By way of one non-limiting example, roasting 18 may include cooking the first plurality of coffee beans in a chamber defined by a rotatable drum, i.e., in a drum roaster, by, firstly, increasing a temperature of the first plurality of coffee beans to from 97° C. to 101° C., e.g., 99.4° C., in the chamber. Firstly increasing may include heating the first plurality of coffee beans at a rate of 10° C. per minute in air until a temperature in the chamber is from 208° C. to 212° C., e.g., 210° C. More specifically, the air may have a mass air flow frequency of from 35 Hz to 45 Hz, e.g., 40 Hz, as measured by a mass airflow sensor as the drum rotates at from 40 Hz to 50 Hz, e.g., 45 Hz.

Roasting 18 may further include secondly increasing the temperature of the first plurality of coffee beans to from 133° C. to 137° C., e.g., 135° C., in the chamber. Secondly increasing may include heating the first plurality of coffee beans at a rate of 12° C. per minute in air until the temperature in the chamber is from 225° C. to 229° C., e.g., 227° C.

Roasting 18 may also include thirdly increasing the temperature of the first plurality of coffee beans to from 166° C. to 170° C. in the chamber. Thirdly increasing may include heating the first plurality of coffee beans at a rate of 12° C. per minute in air until the temperature in the chamber is from 241° C. to 245° C., e.g., 243° C.

In addition, roasting 18 may include fourthly increasing the temperature of the first plurality of coffee beans to from 194° C. to 198° C., e.g., 196° C., in the chamber. Fourthly increasing may include heating the first plurality of coffee beans in air until the temperature in the chamber is from 236° C. to 240° C., e.g., 238° C.

Roasting 18 may additionally include fifthly increasing the temperature of the first plurality of coffee beans to from 210° C. to 214° C., e.g., 212° C., in the chamber to thereby form the first roasted coffee composition. Fifthly increasing may include heating the first plurality of coffee beans in air until the temperature in the chamber is from 230° C. to 234° C., e.g., 232° C.

Referring again to the method 14 as set forth above, after roasting 18 the first green coffee material, the method 14 may include grinding 22 the first roasted coffee composition to form the first ground coffee composition. Grinding 22 may include decreasing a size of the first plurality of coffee beans of the first roasted coffee composition to a specific desired size, e.g., an extra course grind, a coarse grind, a medium coarse grind, a medium grind, a medium fine grind, a fine grind, and an extra fine grind. For example, a coarse grind size may be described as a ground coffee composition having distinct, chunky particles. A medium grind size may be described as a ground coffee composition having a texture of coarse sand. A fine grind size may be described as a ground coffee composition having a texture comparable to salt or sugar. An extra find grind size may be described as a ground coffee composition having a powdery texture. The first roasted coffee composition may be ground by a blade grinder or by a burr grinder.

More specifically, in one non-limiting example, grinding 22 may include decreasing a mean size of the first plurality of coffee beans so that greater than 50 parts by volume of the first plurality of coffee beans, based on 100 parts by volume of the first plurality of coffee beans, have a mean size of 1,180 microns, wherein one micron is equivalent to 1×10⁻⁶ meters. Further, grinding 22 may include decreasing the mean size of the first plurality of coffee beans so that greater than 68.2 parts by volume of the first plurality of coffee beans, based on 100 parts by volume of the first plurality of coffee beans, have a mean size of 1 standard deviation from 1,180 microns.

Referring again to the method 14, contacting 16 may include submerging the first ground coffee composition in water having a temperature of less than 10° C., i.e., room temperature or cold water, for at least 16 hours, e.g., for from 20 hours to 24 hours, to form the first cold brew concentrate. That is, the method 14 may be characterized as a cold-brew coffee process in which the ready-to-drink coffee product 12 is brewed without hot water. Contacting 16 the first ground coffee composition with water may “brew” the first ground coffee composition to extract water-soluble material from the first plurality of coffee beans and produce the first cold brew concentrate.

More specifically, contacting 16 the first ground coffee composition with water may include commingling the first ground coffee composition and water in a first ratio of 4 parts by weight of the first ground coffee composition to 3 parts by volume of water. For example, contacting 16 may include commingling the first ground coffee composition and water in the first ratio of from 1.5 kg to 2.1 kg, e.g., from 1.7 kg to 1.9 kg, of the first ground coffee composition to from 10.5 liters to 13 liters of water, e.g., from 10.6 liters to 12.1 liters.

The method 14 further includes mixing the first cold brew concentrate and water having a temperature of less than 10° C. to form a mixture. For example, mixing 26 may include combining the first cold brew concentrate and water in a mix ratio of parts by volume of the first cold brew concentrate to parts by volume of water of from 1:0.5 to 1:1.5. More specifically, mixing 26 may include combining the first cold brew concentrate and water in the mix ratio of 1 part by volume of the first cold brew concentrate to 1 part by volume of water. Such mixing 26 may dilute the first cold brew concentrate in preparation for further processing and/or to control a taste and potency of the ready-to-drink coffee product 12.

The method 14 further includes heating 28 the mixture to a temperature of less than 100° C. for less than 1 minute to form a pre-fill coffee composition. More specifically, heating 28 may include warming the mixture to a temperature of less than 95° C. and holding the mixture at the temperature of less than 95° C. for less than 35 seconds. For example, heating 28 may include warming the mixture to a temperature of from 90° C. to 93° C. and holding the mixture at from 90° C. to 93° C. for from 25 seconds to 35 seconds. In one non-limiting embodiment, heating 28 may include warming the mixture to the temperature of 91.7° C. and holding the mixture at the temperature of 91.7° C. for 30 seconds. In contrast, heating 28 to a temperature of greater than 100° C. for longer than 1 minute results in a product that is bitter and unappealing to taste.

Without intending to be limited by theory, heating 28 according to the aforementioned parameters may purify the mixture and contribute to the shelf stability and excellent taste of the ready-to-drink coffee product 12. That is, the method 14 does not require the retort heating or aseptic processing that other processes for producing ready-to-drink beverages require, even though the ready-to-drink coffee product 12 may be characterized as a low-acid food. For example, the method 14 does not include warming the mixture to a temperature of at least 120° C. and holding the mixture at the temperature of at least 120° C. for at least 3 minutes, which is customarily required for producing other ready-to-drink beverages. That is, even though heating 28 only includes warming the mixture to a temperature of less than 100° C. and holding the mixture at the temperature of less than 100° C. for less than 1 minute, the method 14 still prevents the growth of spoilage organisms without detrimentally affecting the taste of the ready-to-drink coffee product 12. Consequently, the method 14 does not include adding flavorants, sweeteners, preservatives, and/or acidulants to the ready-to-drink coffee product 12, as set forth in more detail below. As such, the ready-to-drink coffee product 12 produced by the method 14 is economical to produce, transport, and store since the method 14 does not require retort heating or aseptic processing during production, does not require additional ingredients other than coffee and water, and does not require refrigeration of the final ready-to-drink coffee product 12.

As described with reference to FIG. 1, after heating 28, the method 14 includes pouring 30 the pre-fill coffee composition into a cavity 32 defined by a container 34. For example, pouring 30 may include immediately discharging the pre-fill coffee composition into a sealable glass or plastic bottle having a volume of greater than or equal to 147.9 ml. It is to be appreciated that pouring 30 may include immediately discharging the pre-fill coffee composition into the cavity 32 without adding one or more of a sweetener, a preservative, an acidulant, and a flavorant to the pre-fill coffee composition. That is, since heating 28 only includes warming the mixture to the temperature of less than 100° C. and holding the mixture at the temperature of less than 100° C. for less than 1 minute, the taste and quality of the pre-fill coffee composition and eventual ready-to-drink coffee product 12 do not require adjustment from sweeteners, preservatives, acidulants, and/or flavorants.

Concurrent to pouring 30, the method 14 also includes increasing 36 a temperature of the pre-fill coffee composition to at least 82.2° C. and holding the pre-fill coffee composition at the temperature of at least 82.2° C. for at least 30 seconds to form a filled coffee composition. Such increasing 36 may sterilize the container 34 and may prepare the container 34 for sealing, transportation, and storage. That is, increasing 36 the temperature of the pre-fill coffee composition may mitigate a growth of spoilage organisms. The method 14 may also include filtering 38 the pre-fill coffee composition concurrent to pouring 30 to remove, for example, any impurities.

Once the filled coffee composition is disposed within the cavity 32, the method 14 may include sealing the container 34 with a cap 40, and inverting the container 34. That is, the method 14 may include hermetically sealing the container 34. As such, the ready-to-drink coffee product system 10 formed by the method 14 includes the ready-to-drink coffee product 12 disposed within the cavity 32, and the cap 40 disposed on the container 34 so that the cavity 32 is sealed off from an ambient environment.

After increasing 36 the temperature, the method 14 also includes cooling 42 the filled coffee composition to ambient temperature within the cavity 32 to thereby form the ready-to-drink coffee product 12. That is, the method 14 includes decreasing the temperature of the filled coffee composition from the temperature of at least 82.2° C. to ambient temperature. Such cooling 42 may prepare the ready-to-drink coffee product 12 for consumption, transportation, and/or storage at ambient temperature. That is, the ready-to-drink coffee product 12 does not require refrigeration during transportation and storage for at least one year.

In addition, the method 14 may include coding or stamping the ready-to-drink coffee product system 10 with identification materials, coating the container 34 with a label or sleeve, and packing the ready-to-drink coffee product system 10 into a case, pack, and/or pallet for transportation or storage. Further, the method 14 may include, after cooling 42, storing the ready-to-drink coffee product 12 in the cavity 32 for at least one year, and, after storing, testing the ready-to-drink coffee product 12 outside the cavity 32 to produce a test result that indicates that the ready-to-drink coffee product 12 is free from Salmonella, Escherichia coli O157:H7, Listeria monocytogenes and spores of non-proteolytic and proteolytic strains of Clostridium botulinum.

More specifically, the ready-to-drink coffee product 12 may be characterized as free from Salmonella, Escherichia coli O157:H7, Listeria monocytogenes and spores of non-proteolytic and proteolytic strains of Clostridium botulinum for at least one year. Further, the ready-to-drink coffee product 12 may be free from a food additive selected from the group consisting of preservatives, e.g., sodium benzoate and potassium sorbate; sweeteners, e.g., cane sugar, saccharin, aspartame, and sucralose; flavorants, e.g., cocoa powder, cream, chicory, and milk; and acidulants, e.g., citric acid, malic acid, lemon juice, lemon juice concentrate, acetic acid, lactic acid, fumaric acid, tartaric acid, phosphoric acid, and succinic acid, even though the ready-to-drink coffee product 12 may have a pH of greater than 4.6 and a water activity of greater than 0.85. That is, the ready-to-drink coffee product 12 may be characterized as a low-acid coffee material and yet may be free from added preservatives, sweeteners, flavorants, acidulants, and added calories.

Referring now to FIG. 3, in another embodiment, the method 114 may be characterized as an assemblage cold-brewing process. That is, the method 114 may include combining two green coffee materials, as set forth in more detail below.

The method 114 includes roasting 18 the first green coffee material to form the first roasted coffee composition as set forth above. However, the method 114 also includes roasting 20 a second green coffee material that is different from the first green coffee material to form a second roasted coffee composition.

The second green coffee material may include a second plurality of coffee beans or seeds harvested from a coffee plant, such as, by way of non-limiting examples, a Coffea arabica plant or a Coffea canephora, i.e., Coffea robusta, plant. The second green coffee material is unroasted and in natural form, may be mature or immature, and has an intact wax layer on an outer surface of each of the second plurality of coffee beans.

Suitable examples of the second green coffee material include, but are not limited to, any of the examples of the first green coffee material set forth above. However, as noted, the second green coffee material is different from the first green coffee material. Further, the second green coffee material may be procured or sourced from any of the coffee-producing jurisdictions set forth above.

For the method 114, roasting 20 may include cooking the second plurality of coffee beans according to a time-temperature profile or schedule in a coffee roaster. Suitable types of coffee roasters include any of the coffee roasters set forth above. In addition, roasting 20 may include cooking the second plurality of coffee beans in either a batch mode or a continuous mode. Further, roasting 20 the second plurality of coffee beans may be conducted differently than the roasting 18 of the first plurality of coffee beans. For example, roasting 20 may cook the second plurality of coffee beans for a longer or shorter duration and/or at a lower or higher temperature than the roasting conditions of the first plurality of coffee beans.

By way of one non-limiting example, roasting 20 may include cooking the second plurality of coffee beans in the chamber defined by the rotatable drum, i.e., in the drum roaster, by, firstly, increasing a temperature of the second plurality of coffee beans to from 93° C. to 97° C., e.g., 95° C., in the chamber. Firstly increasing may include heating the second plurality of coffee beans at a rate of 12° C. per minute in air until a temperature in the chamber is from 211° C. to 215° C., e.g., 213° C. More specifically, the air may have a mass air flow frequency of from 35 Hz to 45 Hz, e.g., 40 Hz, as measured by a mass airflow sensor, as the drum rotates at from 40 Hz to 50 Hz, e.g., 45 Hz.

Roasting 20 may further include secondly increasing the temperature of the second plurality of coffee beans to from 143° C. to 147° C., e.g., 145° C., in the chamber. Secondly increasing may include heating the second plurality of coffee beans at a rate of 12° C. per minute in air until the temperature in the chamber is from 224° C. to 228° C., e.g., 226° C.

Roasting 20 may also include thirdly increasing the temperature of the second plurality of coffee beans to from 170° C. to 174° C. in the chamber. Thirdly increasing may include heating the second plurality of coffee beans at a rate of 12° C. per minute in air until the temperature in the chamber is from 236° C. to 240° C., e.g., 238° C.

In addition, roasting 20 may include fourthly increasing the temperature of the second plurality of coffee beans to from 196° C. to 200° C., e.g., 198° C., in the chamber. Fourthly increasing may include heating the second plurality of coffee beans in air until the temperature in the chamber is from 241° C. to 245° C., e.g., 243° C.

Roasting 20 may additionally include fifthly increasing the temperature of the second plurality of coffee beans to from 209° C. to 213° C., e.g., 211° C., in the chamber to thereby form the second roasted coffee composition. Fifthly increasing may include heating the second plurality of coffee beans in air until the temperature in the chamber is from 230° C. to 234° C., e.g., 232° C.

Referring again to the method 114, after roasting 20 the second green coffee material, the method 114 includes grinding 24 the second roasted coffee composition to form the second ground coffee composition. Grinding 24 may include decreasing a size of the second plurality of coffee beans of the second roasted coffee composition to a specific desired size, e.g., an extra course grind, a coarse grind, a medium coarse grind, a medium grind, a medium fine grind, a fine grind, and an extra fine grind. The second roasted coffee composition may be ground by a blade grinder or by a burr grinder. Further, grinding 24 the second plurality of coffee beans may grind the second plurality of coffee beans to a different mean size than the mean size of the first plurality of coffee beans after grinding 22 the first plurality of coffee beans.

More specifically, in one non-limiting example, grinding 24 may include decreasing a mean size of the second plurality of coffee beans so that greater than 50 parts by volume of the second plurality of coffee beans, based on 100 parts by volume of the second plurality of coffee beans, have a mean size of 1,180 microns. Further, grinding 24 may include decreasing the mean size of the second plurality of coffee beans so that greater than 68.2 parts by volume of the second plurality of coffee beans, based on 100 parts by volume of the second plurality of coffee beans, have a mean size of 1 standard deviation from 1,180 microns.

Referring again to the method 114, the method 114 includes contacting 116 the second ground coffee composition with water having a temperature of less than 10° C., i.e., room temperature of cold water, for at least 16 hours, e.g., from 20 hours to 24 hours, to form a second cold brew concentrate. That is, the method 14 may be characterized as a cold-brew coffee process in which the ready-to-drink coffee product 112 is brewed without hot water. Contacting 116 the second ground coffee composition with water may “brew” the second ground coffee composition to extract water-soluble material from the second plurality of coffee beans and produce the second cold brew concentrate.

More specifically, contacting 116 the second ground coffee composition with water may include commingling the second ground coffee composition and water in a first ratio of 4 parts by weight of the second ground coffee composition to 3 parts by volume of water. For example, contacting 116 may include commingling the second ground coffee composition and water in the first ratio of from 1.5 kg to 2.1 kg, e.g., 1.7 kg to 1.9 kg, of the second ground coffee composition to from 10.5 liters to 13 liters of water, e.g., from 10.6 liters to 12.1 liters. In one example, the second ground coffee composition may be submerged in the water for at least 16 hours. In another example, the second ground coffee composition may be submerged in the water for at least 20 hours.

The method 114 further includes blending 44 together the first cold brew concentrate and the second cold brew concentrate to form an assemblage concentrate. For example, blending 44 together may include assembling the first cold brew concentrate and the second cold brew concentrate in a mix ratio of parts by volume of the first cold brew concentrate to parts by volume of the second cold brew concentrate of from 1:0.25 to 1:4. More specifically, blending 44 together may include assembling the first cold brew concentrate and the second cold brew concentrate in the mix ratio of from 50 parts by volume to 90 parts by volume, e.g., 70 parts by volume, of the first cold brew concentrate to from 10 parts by volume to 50 parts by volume, e.g., 30 parts by volume, of the second cold brew concentrate. The mix ratio may be selected according to a desired taste and flavor of the ready-to-drink coffee product 112. That is, such blending 44 together may provide the ready-to-drink coffee product 112 with specific taste characteristics based upon the individual respective flavors of the first cold brew concentrate and the second cold brew concentrate.

The method 114 further includes mixing 26 the assemblage concentrate and water having a temperature of less than 10° C. to form a mixture. For example, mixing 26 may include combining the assemblage concentrate and water in a mix ratio of parts by volume of the assemblage concentrate to parts by volume of water of from 1:0.5 to 1:1.5. More specifically, mixing 26 may include combining the assemblage concentrate and water in the mix ratio of 1 part by volume of the assemblage concentrate to 1 part by volume of water. Such mixing 26 may dilute the assemblage concentrate in preparation for further processing and/or to control a taste and potency of the ready-to-drink coffee product 112.

The method 114 further includes heating 28 the mixture to a temperature of less than 100° C. for less than 1 minute to form a pre-fill coffee composition. More specifically, heating 28 may include warming the mixture to a temperature of less than 95° C. and holding the mixture at the temperature of less than 95° C. for less than 35 seconds. For example, heating 28 may include warming the mixture to a temperature of from 90° C. to 93° C. and holding the mixture at from 90° C. to 93° C. for from 25 seconds to 35 seconds. In one non-limiting embodiment, heating 28 may include warming the mixture to the temperature of 91.7° C. and holding the mixture at the temperature of 91.7° C. for 30 seconds.

Without intending to be limited by theory, heating 28 according to the aforementioned parameters may purify the mixture and contribute to the shelf stability and excellent taste of the ready-to-drink coffee product 112. That is, the method 114 does not require retort heating or aseptic processing, e.g., warming the mixture to a temperature of at least 120° C. and holding the mixture at the temperature of at least 120° C. for at least 3 minutes, which is customarily required for other ready-to-drink beverages, even though the ready-to-drink coffee product 112 may be characterized as a low-acid food. Even though heating 28 only includes warming the mixture to a temperature of less than 100° C. and holding the mixture at the temperature of less than 100° C. for less than 1 minute, the method 114 still prevents the growth of spoilage organisms without detrimentally affecting the taste of the ready-to-drink coffee product 112. Consequently, the method 114 does not include adding flavorants, sweeteners, preservatives, and/or acidulants to the ready-to-drink coffee product 112, as set forth in more detail below. As such, the ready-to-drink coffee product 112 produced by the method 114 is economical to produce, transport, and store since the method 114 does not require retort heating or aseptic processing during production, does not require additional ingredients other than coffee and water, and does not require refrigeration of the final ready-to-drink coffee product 112.

After heating 28, the method 114 includes pouring 30 the pre-fill coffee composition into a cavity 32 defined by a container 34. For example, pouring 30 may include immediately discharging the pre-fill coffee composition into a sealable glass or plastic bottle having a volume of greater than or equal to 147.9 ml. It is to be appreciated that pouring 30 may include immediately discharging the pre-fill coffee composition into the cavity 32 without adding one or more of a sweetener, a preservative, an acidulant, and a flavorant to the pre-fill coffee composition. That is, since heating 28 only includes warming the mixture to the temperature of less than 100° C. and holding the mixture at the temperature of less than 100° C. for less than 1 minute, the taste and quality of the pre-fill coffee composition and eventual ready-to-drink coffee product 112 does not require adjustment from sweeteners, preservatives, acidulants, and/or flavorants.

Concurrent to pouring 30, the method 114 also includes increasing 36 a temperature of the pre-fill coffee composition to at least 82.2° C. and holding the pre-fill coffee composition at the temperature of at least 82.2° C. for at least 30 seconds to form a filled coffee composition. Such increasing 36 may sterilize the container 34 and may prepare the container 34 for sealing, transportation, and storage. That is, increasing 36 the temperature of the pre-fill coffee composition may mitigate a growth of spoilage organisms. The method 114 may also include filtering 38 the pre-fill coffee composition concurrent to pouring 30 to remove, for example, any impurities.

Once the filled coffee composition is disposed within the cavity 32, the method 114 may include sealing the container 34 with the cap 40, and inverting the container 34. That is, the method 114 may include hermetically sealing the container 34. As such, the ready-to-drink coffee product system 110 formed by the method 114 includes the ready-to-drink coffee product 112 disposed within the cavity 32, and the cap 40 disposed on the container 34 so that the container 34 is sealed, i.e., so that the cavity 32 is sealed off from the ambient environment.

After increasing 36 the temperature, the method 114 also includes cooling 42 the filled coffee composition to ambient temperature within the cavity 32 to thereby form the ready-to-drink coffee product 112. That is, the method 114 includes decreasing the temperature of the filled coffee composition from the temperature of at least 82.2° C. to ambient temperature. Such cooling 42 may prepare the ready-to-drink coffee product 112 for consumption, transportation, and/or storage at ambient temperature. That is, the ready-to-drink coffee product 112 does not require refrigeration during transportation and storage for at least one year.

In addition, the method 114 may include coding or stamping the ready-to-drink coffee product system 110 with identification materials, coating the container 34 with a label or sleeve, and packing the ready-to-drink coffee product system 110 into a case for transportation or storage. Further, the method 114 may include, after cooling 42, storing the ready-to-drink coffee product 112 in the cavity 32 for at least one year, and, after storing, testing the ready-to-drink coffee product 12 outside the cavity 32 to produce a test result that indicates that the ready-to-drink coffee product 12 is free from Salmonella, Escherichia coli O157:H7, Listeria monocytogenes and spores of non-proteolytic and proteolytic strains of Clostridium botulinum.

More specifically, the ready-to-drink coffee product 112 may be characterized as free from Salmonella, Escherichia coli O157:H7, Listeria monocytogenes and spores of non-proteolytic and proteolytic strains of Clostridium botulinum for at least one year. Further, the ready-to-drink coffee product 112 may be free from a food additive selected from the group consisting of preservatives, e.g., sodium benzoate and potassium sorbate; sweeteners, e.g., cane sugar, saccharin, aspartame, and sucralose; flavorants, e.g., cocoa powder, cream, chicory, and milk; and acidulants, e.g., citric acid, malic acid, lemon juice, lemon juice concentrate, acetic acid, lactic acid, fumaric acid, tartaric acid, phosphoric acid, and succinic acid, even though the ready-to-drink coffee product 112 may have a pH of greater than 4.6 and a water activity of greater than 0.85. That is, the ready-to-drink coffee product 112 may be characterized as a low-acid coffee material and yet may be free from added preservatives, sweeteners, flavorants, acidulants, and added calories.

As such, the disclosed method 14, 114 produces the ready-to-drink coffee product 12, 112 and system 10, 110 that is characterized as low-acid and shelf-stable. That is, the ready-to-drink coffee product system 10, 110 may be transported and stored without refrigeration for at least one year and yet be suitable for human consumption. Further, the ready-to-drink coffee product 12, 112 is free from preservatives, sweeteners, flavorants, and acidulants. The method 14, 114 is economical and does not include retort processing or aseptic processing for retarding a growth of spoilage organisms. That is, the method 14, 114 does not require flash heating at a temperature of, for example, greater than or equal to 120° C., which may otherwise compromise a taste quality of the ready-to-drink coffee product 12, 112.

The following examples illustrate the disclosed technology and are not to be viewed in any way as limiting to the scope of the disclosure.

### EXAMPLES

### Example 1. Preparation of a Ready-to-Drink Coffee Product

One and eighty-one one-hundredths (1.81) kilograms of a first plurality of coffee beans of a first green coffee material, commercially available from Apo and Angra Cooperatives, Papua New Guinea, is submerged in 11.4 liters of water for 16 hours to form a first cold brew concentrate. The first cold brew concentrate is mixed with water having a temperature of 5° C. in a mix ratio of 1 part by volume of the first cold brew concentrate to 1 part by volume of water to form a mixture. The mixture is heated to a temperature of 91.7° C. and held at the temperature of 91.7° C. for 30 seconds to form a pre-fill coffee composition. The pre-fill coffee composition is poured into a cavity defined by a container. Concurrent to pouring, a temperature of the pre-fill coffee composition is increased to 82.2° C. and the pre-fill coffee composition is held at the temperature of 82.2° C. for 30 seconds to form a filled coffee composition. The filled coffee composition is cooled to ambient temperature to form the ready-to-drink coffee product of Example 1. No sweetener, preservative, acidulant, or flavorant is added to the ready-to-drink coffee product of Example 1.

### Initial Analysis of Example 1

A pH of the ready-to-drink coffee product of Example 1 is adjusted to 5.40+/−0.05 with 6N sodium hydroxide. A water activity of the ready-to-drink coffee product is not substantially altered during pH adjustment. After adjusting the pH, aliquots of the ready-to-drink coffee product are artificially inoculated with a low level of proteolytic C. botulinum spores and a low level of non-proteolytic C. botulinum spores. Inoculated samples and uninoculated negative control samples are incubated anaerobically at 30° C. for 12 months. Samples are tested for C. botulinum toxin initially and at pre-determined sampling times using a mouse bioassay.

Three independent samples of uninoculated negative control samples are measured initially for pH, water activity (a_{w}), ° Brix, and titratable acidity. Additionally, three samples of uninoculated negative control samples are tested as a composite sample for Clostridium botulinum toxin, and independently for total aerobic organisms, total anaerobic organisms, yeast, and mold using standard microbiological methods described in Table 1. All results are reported as colony forming units (CFU) per ml of sample.

TABLE 1
Summary of microbiological analyses.

| | | | | Incu- |
|---|---|---|---|---|
| | | | Incu- | bation |
| | | | bation | Temper- |
| Analysis | Method | Media | Time | ature |
| Clostridium | Mouse | n/a | n/a | n/a |
| botulinum | bioassay, | | | |
| toxin | FDA BAM, | | | |
| | 8th edition | | | |
| Total aerobic | FDA BAM, | Plate Count | 48 ± 2 hours | 35 ± 1° C. |
| organisms | 8th edition | Agar | | |
| Total | In house | TPGYE-1% | 3 days | 30 ± 1° C. |
| anaerobic | method | NaThio | | |
| organisms | | | | |
| Yeast and | Compendium, | Acidified | 5 days | 25 ± 5° C. |
| mold | 4th edition | Potato | | |
| | | Dextrose Agar | | |

FDA Bacteriological Analytical Manual (FDA BAM);
Compendium of Methods for the Microbiological Examination of Food, 4th edition (Comp., 4th edition);
Tryptone Peptone Glucose Yeast Extract Agar with 1% sodium thioglycolate (TYGYE-1% NaThio);
n/a, not applicable

### Preparation of Organisms

Two separate spore cocktails are prepared. One cocktail includes six different strains of non-proteolytic Clostridium botulinum, three type B and three type E, based on an ability to produce botulinum toxin, as summarized in Table 2. A second cocktail includes ten different strains of proteolytic C. botulinum, five type A and five type B, also selected based upon an ability to produce botulinum toxin, as summarized in Table 3. The concentration of each spore crop is determined by plating a heat-shocked (60° C. for 10 minutes for non-proteolytics and 80° C. for 10 minutes for proteolytics) aliquot of each strain spore suspension onto Tryptone Peptone Glucose Yeast Extract (TPGYE) agar with 0.1% sodium thioglycolate, and incubating the plates anaerobically for 3 days at 30° C. Using counts obtained for each strain, equivalent concentrations of spores are combined to form multi-strain cocktails of non-proteolytic and proteolytic C. botulinum spores. A concentration of each spore inoculum is adjusted to a target level using sterile distilled water and verified by plating a heat-shocked aliquot of the suspensions as described above.

TABLE 2
Strains of non-proteolytic C. botulinum.

| | | Mouse Lethal Dose |
|---|---|---|
| Type | Strain ID | (MLD)/ml |
| Non-proteolytic, | Kapchunka B | >1000 MLD |
| Type B | 17B | >1000 MLD |
| | 2129B | >1000 MLD |
| Non-proteolytic, | Saratoga E | >1000 MLD |
| Type E | Birmingham E | >1000 MLD |
| | Tennessee E | >1000 MLD |

TABLE 3
Strains of proteolytic C. botulinum.

| | | Mouse Lethal Dose |
|---|---|---|
| Type | Strain ID | (MLD)/ml |
| Proteolytic, | 19A | >1000 MLD |
| Type A | 56A | >1000 MLD |
| | 69A | >1000 MLD |
| | 78A | >1000 MLD |
| | 90A | >1000 MLD |
| Proteolytic, | 13B | >1000 MLD |
| Type B | 32B | >1000 MLD |
| | 113B | >1000 MLD |
| | 169B | >1000 MLD |
| | 213B | >1000 MLD |

### Inoculation of the Ready-to-Drink Coffee Product of Example 1

Shortly prior to inoculation, each C. botulinum cocktail inoculum is heat-shocked to destroy any preformed toxin present and to activate a germination process of the spores. The ready-to-drink coffee product of Example 1 is aseptically dispensed into sterile glass tubes in an amount of from 10 g to 25 g of ready-to-drink coffee product per tube (25 g used for uninoculated samples, 10 g used for inoculated samples). Each tube is considered to be one sample. Samples are heat-exhausted to aid in the removal of dissolved oxygen then cooled briefly prior to inoculation. Samples are individually inoculated with 100 μl of a single heat-shocked C. botulinum cocktail inoculum to target 101 colony forming units (CFU) to 102 colony forming units per gram of ready-to-drink coffee product. Immediately after inoculation, an anaerobic environment is created by sealing the ready-to-drink coffee product with a layer of sterile vaspar. Uninoculated samples are treated in the same manner but are not inoculated.

After inoculation, five samples inoculated with non-proteolytic C. botulinum and five samples inoculated with proteolytic C. botulinum are enumerated for target organisms as described under “Enumeration of Target Organisms.” Counts for these samples and the inoculums are used to establish an initial population level of each organism in the inoculated samples. In addition, five samples inoculated with non-proteolytic C. botulinum are composited and five samples inoculated with proteolytic C. botulinum are composited. These composited samples are tested for the presence of C. botulinum toxin using the mouse bioassay as described under “Botulinum Toxin Bioassay.” The data collected at this time interval are the initial or “Time 0” time point.

### Incubation

All samples are incubated anaerobically at an elevated room temperature of 30° C. along with uninoculated negative controls.

Testing for C. botulinum

At each sampling point described in Table 4, five inoculated replicate samples per organism and two uninoculated replicate samples are removed from the incubator and visually examined for signs of microbial growth (gas production, discoloration, texture changes, etc.). Each set of inoculated samples is then composited among replicates and evaluated alongside the composite uninoculated replicates for C. botulinum toxin using the mouse bioassay as described under “Botulinum Toxin Bioassay.” In addition, the population of C. botulinum is determined for all replicates after 10 and 12 weeks and 6, 9, and 12 months of incubation.

TABLE 4
Sampling dates for all inoculated and
uninoculated samples incubated at 30° C.
Sampling Dates

1, 2, 4, 6, 8, 10, 12 weeks and 4, 5, 6, 7, 8, 9, 10, 11, 12 months

In addition to testing the uninoculated samples for C. botulinum toxin, all uninoculated samples are also tested for pH, water activity, total aerobic organisms, total anaerobic organisms, and yeast and mold using microbiological methods previously described in Table 1.

### Botulinum Toxin Bioassay

Each composite sample is tested in duplicate (two mice per sample) for botulinum toxin using an abbreviation of the mouse bioassay procedure outlined in the FDA's Bacteriological Analytical Manual (FDA BAM, 8th edition) where only a 1:2 dilution with gel phosphate buffer is tested. Samples inoculated with non-proteolytic C. botulinum are adjusted to pH 6.2 and treated with trypsin prior to analysis. Results are reported as either positive or negative.

### Enumeration of Target Organisms

Samples are serially diluted into sterile 0.1% peptone water, stomached or vortexed, and then enumerated in duplicate onto TPGYE agar with 0.1% sodium thioglycolate. Plates are incubated anaerobically for 3 days at 30° C. Colonies are counted as C. botulinum based on colony morphology.

For the microbiological test results, duplicate plates are averaged to obtain a population of organisms recovered from each sample. Sample replicates are then averaged to determine an average population of organisms from a given sample set. For the analytical test results, results for replicates are averaged and the standard deviation is determined.

### Results

Results for the analytical and microbiological analysis of the ready-to-drink coffee product of Example 1 are provided in Table A1. The pH of the ready-to-drink coffee product of Example 1 is then adjusted to pH 5.40±0.05. (The actual measurements are 5.40, 5.38, and 5.37.) A minimum pH required for growth of proteolytic and non-proteolytic C. botulinum from a spore state is reported to be 4.6 and 5.0, respectively, when all other conditions are optimal. Therefore, the pH of the ready-to-drink coffee product of Example 1 is initially within range to support the growth of both types of C. botulinum, excluding other growth factors.

Results for the C. botulinum challenge studies are provided in Tables B1 through B4 and summarized in Table 5. Pass/fail criteria recommended for C. botulinum challenge studies is based upon a detection of toxins rather than evidence of population growth, as C. botulinum toxin may be formed without an increase in number. Results indicate that the ready-to-drink coffee product of Example 1 does not support C. botulinum growth or toxin production throughout 12 months of incubation under ideal conditions for this pathogen.

TABLE A1
Initial analytical and microbiological analysis of the ready-to-drink coffee product of Example 1.

| Analysis | Replicate 1 | Replicate 2 | Replicate 3 | Average ± SD |
|---|---|---|---|---|
| pH | 5.17 | 5.20 | 5.19 | 5.19 ± 0.02 |
| Water Activity | 0.9825 @ 24.86° C. | 0.9892 @ 25.04° C. | 0.9863 @ 24.83° C. | 0.9860 ± 0.0034 |
| Clostridium | Negative | Negative | Negative | Negative |
| botulinum toxin¹ | | | | |
| Total aerobic | <10* | <10* | <10* | <10* |
| organisms | | | | |
| (CFU/ml) | | | | |
| Total anaerobic | <10* | <10* | <10* | <10* |
| organisms | | | | |
| (CFU/ml) | | | | |
| Yeast (CFU/ml) | <10* | <10* | <10* | <10* |
| Mold (CFU/ml) | <10* | <10* | <10* | <10* |

¹Evaluted as a composite sample; Average and standard deviation calculated by assigning estimated counts <10*CFU/ml as 10 CFU/ml;
*Estimated count

TABLE B1
Population of proteolytic C. botulinum recovered from the spore
inoculum suspension and calculated population artificially added to
10 ml samples of the ready-to-drink coffee product of Example 1.

| Inoculum Procedure | Value | |
|---|---|---|
| A. Population concentration of C. | 5.50 × 10³ | CFU/ml |
| botulinum in cocktail inoculum¹ | | |
| B. Volume of inoculum suspension added | 0.1 | ml |
| per 10 ml sample | | |
| C. Total population of C. botulinum per | 5.50 × 10² | CFU |
| sample (= A × B) | | |

| | |
|---|---|
| D. Population concentration of C. | 55 CFU/ml or |
| botulinum per 10 ml sample (= C/10 ml) | 1.74 Log₁₀ CFU/m |

¹As determined by enumerating the cocktail inoculum onto TYGYE-1% Na-Thio

TABLE B2
Population of non-proteolytic C. botulinum recovered from the spore
inoculum suspension and calculated population artificially added to
10 ml samples of the ready-to-drink coffee product of Example 1.

| Inoculum Procedure | Value | |
|---|---|---|
| A. Population concentration of C. | 5.80 × 103 | CFU/ml |
| botulinum in cocktail inoculum 1 | | |
| B. Volume of inoculum suspension added | 0.1 | ml |
| per 10 ml sample | | |
| C. Total population of C. botulinum per ml | 5.80 × 102 | CFU |
| g sample (= A × B) | | |

| | |
|---|---|
| D. Population concentration of C. | 58 CFU/ml or |
| botulinum per 10 ml sample (= C/10 ml) | 1.76 Log10 CFU/m |

1 As determined by enumerating the cocktail inoculum onto TYGYE-1% Na-Thio

TABLE B3
Recovery of proteolytic C. botulinum from artificially
inoculated samples of the ready-to-drink coffee product of
Example 1 and analysis of C. botulinum toxin in inoculated
composite samples after incubation at 30° C.

| | | | C. botulinum | C. botulinum |
|---|---|---|---|---|
| Sampling | | Sample Odor/ | toxin (positive | (Log₁₀ |
| Date | Replicate | Appearance | or negative) | CFU/ml) |
| Time 0 | 1 | Normal/Normal | Negative | 1.50 |
| | 2 | Normal/Normal | | 1.54 |
| | 3 | Normal/Normal | | 1.69 |
| | 4 | Normal/Normal | | 1.63 |
| | 5 | Normal/Normal | | 1.61 |
| | Ave ± SD | — | | 1.59 ± 0.08 |
| Week 1 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 2 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 4 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 6 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 8 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 10 | 1 | Normal/Normal | Negative | 1.35* |
| | 2 | Normal/Normal | | 1.16* |
| | 3 | Normal/Normal | | 1.26* |
| | 4 | Normal/Normal | | 1.19* |
| | 5 | Normal/Normal | | 1.31* |
| | Ave ± SD | — | | 1.25 ± 0.08 |
| Week 12 | 1 | Normal/Normal | Negative | 1.65 |
| | 2 | Normal/Normal | | 1.45 |
| | 3 | Normal/Normal | | 1.56 |
| | 4 | Normal/Normal | | 1.45 |
| | 5 | Normal/Normal | | 1.38* |
| | Ave ± SD | — | | 1.50 ± 0.11 |
| Month 4 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 5 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 6 | 1 | Normal/Normal | Negative | 1.20* |
| | 2 | Normal/Normal | | 1.13* |
| | 3 | Normal/Normal | | 0.60* |
| | 4 | Normal/Normal | | 0.48* |
| | 5 | Normal/Normal | | 0.48* |
| | Ave ± SD | — | | 0.78 ± 0.36 |
| Month 7 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 8 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 9 | 1 | Normal/Normal | Negative | <0.00* |
| | 2 | Normal/Normal | | 0.18* |
| | 3 | Normal/Normal | | <0.00* |
| | 4 | Normal/Normal | | 0.18* |
| | 5 | Normal/Normal | | 0.18* |
| | Ave ± SD | — | | <0.00 ± 0.26 |
| Month 10 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 11 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 12 | 1 | Normal/Normal | Negative | 1.16* |
| | 2 | Normal/Normal | | 0.95* |
| | 3 | Normal/Normal | | 1.51 |
| | 4 | Normal/Normal | | 1.45 |
| | 5 | Normal/Normal | | 1.18* |
| | Ave ± SD | — | | 1.25 ± 0.23 |

*Estimated count, average colony count below 25 CFU on lowest dilution plated;
ND, not determined

TABLE B4
Recovery of non-proteolytic C. botulinum from artificially inoculated
samples of coffee beverage product and analysis of C. botulinum toxin
in inoculated composite samples after incubation at 30° C.

| | | | C. botulinum | C. botulinum |
|---|---|---|---|---|
| Sampling | | Sample Odor/ | toxin (positive | (Log₁₀ |
| Date | Replicate | Appearance | or negative) | CFU/ml) |
| Time 0 | 1 | Normal/Normal | Negative | 1.73 |
| | 2 | Normal/Normal | | 1.86 |
| | 3 | Normal/Normal | | 1.78 |
| | 4 | Normal/Normal | | 1.85 |
| | 5 | Normal/Normal | | 1.88 |
| | Ave ± SD | — | | 1.82 ± 0.06 |
| Week 1 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 2 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 4 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 6 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 8 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Week 10 | 1 | Normal/Normal | Negative | 2.02 |
| | 2 | Normal/Normal | | 2.05 |
| | 3 | Normal/Normal | | 1.85 |
| | 4 | Normal/Normal | | 2.11 |
| | 5 | Normal/Normal | | 2.10 |
| | Ave ± SD | — | | 2.02 ± 0.10 |
| Week 12 | 1 | Normal/Normal | Negative | 1.77 |
| | 2 | Normal/Normal | | 1.72 |
| | 3 | Normal/Normal | | 1.67 |
| | 4 | Normal/Normal | | 1.67 |
| | 5 | Normal/Normal | | 1.85 |
| | Ave ± SD | — | | 1.74 ± 0.08 |
| Month 4 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 5 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 6 | 1 | Normal/Normal | Negative | 1.18* |
| | 2 | Normal/Normal | | 0.98* |
| | 3 | Normal/Normal | | 0.95* |
| | 4 | Normal/Normal | | 1.56 |
| | 5 | Normal/Normal | | 1.11* |
| | Ave ± SD | — | | 1.16 ± 0.24 |
| Month 7 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 8 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 9 | 1 | Normal/Normal | Negative | 1.46 |
| | 2 | Normal/Normal | | 0.54* |
| | 3 | Normal/Normal | | 0.54* |
| | 4 | Normal/Normal | | 0.54* |
| | 5 | Normal/Normal | | 0.88* |
| | Ave ± SD | — | | 0.79 ± 0.40 |
| Month 10 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 11 | 1 | Normal/Normal | Negative | ND |
| | 2 | Normal/Normal | | ND |
| | 3 | Normal/Normal | | ND |
| | 4 | Normal/Normal | | ND |
| | 5 | Normal/Normal | | ND |
| | Ave ± SD | — | | ND |
| Month 12 | 1 | Normal/Normal | Negative | 1.43 |
| | 2 | Normal/Normal | | 1.31* |
| | 3 | Normal/Normal | | 1.70 |
| | 4 | Normal/Normal | | 1.54 |
| | 5 | Normal/Normal | | 1.28* |
| | Ave ± SD | — | | 1.45 ± 0.17 |

*Estimated count, average colony count below 25 CFU on lowest dilution plated;
ND, not determined

TABLE 5
Summary of C. botulinum challenge study results.

| Organism | Incubation Temperature 30° C. |
|---|---|
| C. botulinum, | No toxin or growth detected throughout 12 months |
| proteolytic type | |
| C. botulinum, | No toxin or growth detected throughout 12 months |
| non-proteolytic type | |

Results for the analytical analysis of the uninoculated microbiological controls are provided in Table C1. While some variance between replicates is observed, in general, the pH of the uninoculated samples drops from an initial level of pH 5.4 to an approximate final level of pH 4.9. An odor, appearance, and water activity of the samples remains consistent.

TABLE C1
Analytical analysis of uninoculated coffee
beverage samples after incubation at 30° C.

| Sampling | | Sample Odor/ | Sample | Sample Water |
|---|---|---|---|---|
| Date | Replicate | Appearance | pH | Activity |
| Time 0 | 1 | Normal/Normal | 5.37 | 0.9937 @ 24.83° C. |
| | 2 | Normal/Normal | 5.38 | 0.9960 @ 24.96° C. |
| Week 1 | 1 | Normal/Normal | 5.17 | 0.9924 @ 24.80° C. |
| | 2 | Normal/Normal | 5.19 | 0.9889 @ 24.82° C. |
| Week 2 | 1 | Normal/Normal | 5.19 | 0.9998 @ 24.97° C. |
| | 2 | Normal/Normal | 5.11 | 1.0008 @ 24.97° C. |
| Week 4 | 1 | Normal/Normal | 5.14 | 0.9882 @ 24.83° C. |
| | 2 | Normal/Normal | 5.18 | 0.9927 @ 24.95° C. |
| Week 6 | 1 | Normal/Normal | 5.07 | 0.9905 @ 25.00° C. |
| | 2 | Normal/Normal | 5.00 | 0.9915 @ 25.00° C. |
| Week 8 | 1 | Normal/Normal | 4.91 | 0.9915 @ 25.00° C. |
| | 2 | Normal/Normal | 4.84 | 0.9940 @ 25.01° C. |
| Week 10 | 1 | Normal/Normal | 5.07 | 0.9885 @ 24.98° C. |
| | 2 | Normal/Normal | 5.09 | 0.9912 @ 25.00° C. |
| Week 12 | 1 | Normal/Normal | 5.09 | 0.9821 @ 24.85° C. |
| | 2 | Normal/Normal | 5.03 | 0.9882 @ 24.96° C. |
| Month 4 | 1 | Normal/Normal | 4.94 | 0.9890 @ 25.02° C. |
| | 2 | Normal/Normal | 4.93 | 0.9824 @ 24.93° C. |
| Month 5 | 1 | Normal/Normal | 4.90 | 0.9823 @ 24.95° C. |
| | 2 | Normal/Normal | 4.91 | 0.9831 @ 24.82° C. |
| Month 6 | 1 | Normal/Normal | 4.94 | 0.9933 @ 24.98° C. |
| | 2 | Normal/Normal | 4.94 | 0.9957 @ 24.92° C. |
| Month 7 | 1 | Normal/Normal | 4.94 | 0.9923 @ 24.63° C. |
| | 2 | Normal/Normal | 4.92 | 0.9924 @ 24.87° C. |
| Month 8 | 1 | Normal/Normal | 4.99 | 0.9906 @ 24.99° C. |
| | 2 | Normal/Normal | 5.02 | 0.9928 @ 24.99° C. |
| Month 9 | 1 | Normal/Normal | 4.83 | 0.9900 @ 24.81° C. |
| | 2 | Normal/Normal | 4.86 | 0.9889 @ 24.91° C. |
| Month 10 | 1 | Normal/Normal | 4.94 | 0.9899 @ 24.79° C. |
| | 2 | Normal/Normal | 4.89 | 0.9860 @ 24.70° C. |
| Month 11 | 1 | Normal/Normal | 4.88 | 0.9947 @ 24.92° C. |
| | 2 | Normal/Normal | 4.91 | 0.9881 @ 24.69° C. |
| Month 12 | 1 | Normal/Normal | 4.92 | 0.9971 @ 24.96° C. |
| | 2 | Normal/Normal | 4.92 | 0.9941 @ 24.91° C. |

Results for the microbiological analysis of the uninoculated negative controls are provided in Table C2. The data demonstrate that the uninoculated samples of the ready-to-drink coffee product of Example 1 remain microbiologically unspoiled and consistent with regard to initial state. C. botulinum toxin is not detected in any of the samples of the ready-to-drink coffee product of Example 1.

TABLE C2
Microbiological analysis of uninoculated coffee beverage samples after
incubation at 30° C.

| | | C. botulinum | | | | |
|---|---|---|---|---|---|---|
| | | toxin | Organisms (CFU/ml) | | | |
| Sampling | | (positive or | Total | Total | | |
| Date | Replicate | negative) | aerobic¹ | anaerobic² | Yeast | Mold |
| Time 0 | 1 | Negative | <1* | <1* | <1* | <1* |
| | 2 | Negative | <1* | <1* | <1* | 1* |
| Week 1 | 1 | Negative | <1* | <1* | <1* | <1* |
| | 2 | Negative | <1* | <1* | <1* | <1* |
| Week 2 | 1 | Negative | <1* | <1* | <1* | <1* |
| | 2 | Negative | <1* | <1* | <1* | <1* |
| Week 4 | 1 | Negative | 1* | <1* | <1* | <1* |
| | 2 | Negative | 3* | <1* | <1* | <1* |
| Week 6 | 1 | Negative | <1* | <1* | <1* | <1* |
| | 2 | Negative | <1* | <1* | <1* | <1* |
| Week 8 | 1 | Negative | 1* | <1* | <1* | <1* |
| | 2 | Negative | <1* | <1* | <1* | <1* |
| Week 10 | 1 | Negative | <1* | <1* | <1* | <1* |
| | 2 | Negative | <1* | <1* | <1* | <1* |
| Week 12 | 1 | Negative | <1* | <1* | <1* | <1* |
| | 2 | Negative | <1* | <1* | <1* | <1* |
| Month 4 | 1 | Negative | <1* | <1* | <1* | <1* |
| | 2 | Negative | <1* | <1* | <1* | <1* |
| Month 5 | 1 | Negative | <1* | <1* | <1* | <1* |
| | 2 | Negative | <1* | <1* | <1* | <1* |
| Month 6 | 1 | Negative | <1* | <1* | <1* | <1* |
| | 2 | Negative | <1* | <1* | <1* | <1* |
| Month 7 | 1 | Negative | <1* | <1* | <1* | <1* |
| | 2 | Negative | <1* | <1* | <1* | <1* |
| Month 8 | 1 | Negative | <1* | <1* | <1* | <1* |
| | 2 | Negative | <1* | <1* | <1* | <1* |
| Month 9 | 1 | Negative | <1* | <1* | <1* | <1* |
| | 2 | Negative | <1* | <1* | <1* | <1* |
| Month 10 | 1 | Negative | <1* | <1* | <1* | <1* |
| | 2 | Negative | <1* | <1* | <1* | <1* |
| Month 11 | 1 | Negative | <1* | <1* | <1* | <1* |
| | 2 | Negative | <1* | <1* | <1* | <1* |
| Month 12 | 1 | Negative | <1* | <1* | <1* | <1* |
| | 2 | Negative | <1* | <1* | <1* | <1* |

¹Total aerobic organisms enumerated onto PCA;
²Total anaerobic organisms enumerated onto TPGYE + 0.1% sodium-thio;
*Estimated count reported, average colony count outside of countable range (25-250 bacteria, 10-100 yeast/mold)

Results indicate that the ready-to-drink coffee product of Example 1 does not support C. botulinum growth or toxin production throughout 12 months of incubation at 30° C. under anaerobic conditions. In addition, the ready-to-drink coffee product remains microbiologically stable throughout 12 months of incubation. The drop in pH observed for the uninoculated samples does not appear to correlate to microbiological activity.

While the best modes for carrying out the disclosure have been described in detail, those familiar with the art to which this disclosure relates will recognize various alternative designs and embodiments for practicing the disclosure within the scope of the appended claims.

1. A method of forming a ready-to-drink coffee product, the method comprising:
contacting a first ground coffee composition with water having a temperature of less than 10° C. for at least 16 hours to form a first cold brew concentrate;
mixing the first cold brew concentrate and water having a temperature of less than 10° C. to form a mixture;
heating the mixture to a temperature of less than 100° C. for less than 1 minute to form a pre-fill coffee composition;
after heating, pouring the pre-fill coffee composition into a cavity defined by a container;
concurrent to pouring, increasing a temperature of the pre-fill coffee composition to at least 82.2° C. and holding the pre-fill coffee composition at the temperature of at least 82.2° C. for at least 30 seconds to form a filled coffee composition; and
after increasing the temperature, cooling the filled coffee composition to ambient temperature within the cavity to thereby form the ready-to-drink coffee product.

2. The method of claim 1, wherein heating includes warming the mixture to a temperature of less than 95° C. and holding the mixture at the temperature of less than 95° C. for less than 35 seconds.

3. The method of claim 1, wherein heating includes warming the mixture to a temperature of from 90° C. to 93° C. and holding the mixture at the temperature of from 90° C. to 93° C. for from 25 seconds to 35 seconds.

4. The method of claim 1, wherein pouring includes immediately discharging the pre-fill coffee composition into the cavity without adding one or more of a sweetener, a preservative, an acidulant, and a flavorant to the pre-fill coffee composition.

5. The method of claim 1, wherein contacting includes commingling the first ground coffee composition and water in a first ratio of from 1.5 kg to 2.1 kg of the first ground coffee composition to from 10.5 liters to 13 liters of water.

6. The method of claim 1, wherein mixing includes combining the first cold brew concentrate and water in a mix ratio of parts by volume of the first cold brew concentrate to parts by volume of water of from 1:0.5 to 1:1.1.5.

7. A ready-to-drink coffee product formed by the method of claim 1,
wherein the ready-to-drink coffee product is free from Salmonella, Escherichia coli O157:H7, Listeria monocytogenes and spores of non-proteolytic and proteolytic strains of Clostridium botulinum for at least one year;
wherein the ready-to-drink coffee product is free from a food additive selected from the group consisting of preservatives, sweeteners, flavorants, and acidulants; and
wherein the ready-to-drink coffee product has a pH of greater than 4.6 and a water activity of greater than 0.85.

8. A ready-to-drink coffee product system comprising the ready-to-drink coffee product of claim 7 disposed within the cavity, and a cap disposed on the container.

9. A ready-to-drink coffee product system comprising:
a container defining a cavity;
a cap disposed on the container so that the cavity is sealed off from an ambient environment; and
a ready-to-drink coffee product disposed within the cavity, wherein the ready-to-drink coffee product is formed by:
contacting a first ground coffee composition with water having a temperature of less than 10° C. for at least 16 hours to form a first cold brew concentrate;
mixing the first cold brew concentrate and water having a temperature of less than 10° C. to form a mixture;
heating the mixture to a temperature of less than 100° C. for less than 1 minute to form a pre-fill coffee composition;
after heating, pouring the pre-fill coffee composition into the cavity;
concurrent to pouring, increasing a temperature of the pre-fill coffee composition to at least 82.2° C. and holding the pre-fill coffee composition at the temperature of at least 82.2° C. for at least 30 seconds to form a filled coffee composition; and
after increasing the temperature, cooling the filled coffee composition to ambient temperature within the cavity to thereby form the ready-to-drink coffee product.

10. A method of forming a ready-to-drink coffee product, the method comprising:
roasting a first green coffee material and a second green coffee material that is different from the first green coffee material to form a first roasted coffee composition and a second roasted coffee composition, respectively;
grinding the first roasted coffee composition and the second roasted coffee composition to form a first ground coffee composition and a second ground coffee composition, respectively;
contacting the first ground coffee composition with water having a temperature of less than 10° C. for at least 16 hours to form a first cold brew concentrate;
contacting the second ground coffee composition with water having a temperature of less than 10° C. for at least 16 hours to form a second cold brew concentrate;
blending together the first cold brew concentrate and the second cold brew concentrate to form an assemblage concentrate;
mixing the assemblage concentrate and water having a temperature of less than 10° C. to form a mixture;
heating the mixture to a temperature of less than 100° C. for less than 1 minute to form a pre-fill coffee composition;
after heating, pouring the pre-fill coffee composition into a cavity defined by a container;
concurrent to pouring, increasing a temperature of the pre-fill coffee composition to at least 82.2° C. and holding the pre-fill coffee composition at the temperature of at least 82.2° C. for at least 30 seconds to form a filled coffee composition; and
after increasing the temperature, cooling the filled coffee composition to ambient temperature within the cavity to thereby form the ready-to-drink coffee product.

11. The method of claim 10, wherein heating includes warming the mixture to a temperature of less than 95° C. and holding the mixture at the temperature of less than 95° C. for less than 35 seconds.

12. The method of claim 10, wherein heating includes warming the mixture to a temperature of 91.7° C. and holding the mixture at the temperature of 91.7° C. for 30 seconds.

13. The method of claim 10, wherein the first green coffee material includes a first plurality of coffee beans, and wherein roasting the first green coffee material includes cooking the first plurality of coffee beans by:
firstly increasing a temperature of the first plurality of coffee beans to from 97° C. to 101° C. in a chamber defined by a rotatable drum, wherein firstly increasing includes heating the first plurality of coffee beans at a rate of 10° C. per minute in air until the temperature in the chamber is from 208° C. to 212° C.;
secondly increasing the temperature of the first plurality of coffee beans to from 133° C. to 137° C. in the chamber, wherein secondly increasing includes heating the first plurality of coffee beans at a rate of 12° C. per minute in air until the temperature in the chamber is from 225° C. to 229° C.;
thirdly increasing the temperature of the first plurality of coffee beans to from 166° C. to 170° C. in the chamber, wherein thirdly increasing includes heating the first plurality of coffee beans at a rate of 12° C. per minute in air until the temperature in the chamber is from 241° C. to 245° C.;
fourthly increasing the temperature of the first plurality of coffee beans to from 194° C. to 198° C. in the chamber, wherein fourthly increasing includes heating the first plurality of coffee beans in air until the temperature in the chamber is from 236° C. to 240° C.; and
fifthly increasing the temperature of the first plurality of coffee beans to from 210° C. to 214° C. in the chamber to thereby form the first roasted coffee composition, wherein fifthly increasing includes heating the first plurality of coffee beans in air until the temperature in the chamber is from 230° C. to 234° C.

14. The method of claim 10, wherein the second green coffee material includes a second plurality of coffee beans, and wherein roasting the second green coffee material includes cooking the second plurality of coffee beans by:
firstly increasing a temperature of the second plurality of coffee beans to from 93° C. to 97° C. in a chamber defined by a rotatable drum, wherein firstly increasing includes heating the second plurality of coffee beans at a rate of 12° C. per minute in air until the temperature in the chamber is from 211° C. to 215° C.;
secondly increasing the temperature of the second plurality of coffee beans to from 143° C. to 147° C. in the chamber, wherein secondly increasing includes heating the second plurality of coffee beans at a rate of 12° C. per minute in air until the temperature in the chamber is from 224° C. to 228° C.;
thirdly increasing the temperature of the second plurality of coffee beans to from 170° C. to 174° C. in the chamber, wherein thirdly increasing includes heating the second plurality of coffee beans at a rate of 12° C. per minute in air until the temperature in the chamber is from 236° C. to 240° C.;
fourthly increasing the temperature of the second plurality of coffee beans to from 196° C. to 200° C. in the chamber, wherein fourthly increasing includes heating the second plurality of coffee beans in air until the temperature in the chamber is from 241° C. to 245° C.; and
fifthly increasing the temperature of the second plurality of coffee beans to from 209° C. to 213° C. in the chamber to thereby form the second roasted coffee composition, wherein fifthly increasing includes heating the second plurality of coffee beans in air until the temperature in the chamber is from 230° C. to 234° C.

15. The method of claim 10, wherein grinding includes decreasing a mean size of the first plurality of coffee beans and the second plurality of coffee beans so that greater than 50 parts by volume of the first plurality of coffee beans, based on 100 parts by volume of the first plurality of coffee beans, and greater than 50 parts by volume of the second plurality of coffee beans, based on 100 parts by volume of the second plurality of coffee beans, have a mean size of 1180 microns.

16. The method of claim 10, wherein contacting the first ground coffee composition with water includes commingling the first ground coffee composition and water in a first ratio of from 1.7 kg to 1.9 kg of the first ground coffee composition to from 10.6 liters to 12.1 liters of water.

17. The method of claim 16, wherein contacting the second ground coffee composition with water includes commingling the second ground coffee composition and water in a second ratio of from 1.7 kg to 1.9 kg of the second ground coffee composition to from 10.6 liters to 12.1 liters of water.

18. The method of claim 10, wherein blending includes assembling the first cold brew concentrate and the second cold brew concentrate in a mix ratio of parts by volume of the first cold brew concentrate to parts by volume of the second cold brew concentrate of from 1:0.25 to 1:4.

19. The method of claim 10, wherein mixing the assemblage concentrate and water includes combining the assemblage concentrate and water in a mix ratio of parts by volume of the assemblage concentrate to parts by volume of water of from 1:0.5 to 1:1.5.

20. A ready-to-drink coffee product formed by the method of claim 10,
wherein the ready-to-drink coffee product is free from Salmonella, Escherichia coli O157:H7, Listeria monocytogenes and spores of non-proteolytic and proteolytic strains of Clostridium botulinum for at least one year;
wherein the ready-to-drink coffee product is free from a food additive selected from the group consisting of preservatives, sweeteners, flavorants, and acidulants; and
wherein the ready-to-drink coffee product has a pH of greater than 4.6 and a water activity of greater than 0.85.
